(19) United States
(12) Patent Application Publication
(10) Pub. No.: US 2011/0030628 A1
(43) Pub. Date: Feb. 10, 2011

(54) TWO-CYCLE DRY-SUMP FUEL-INJECTED ENGINE

(76) Inventor: Richard Tony Main, Las Vegas, NV (US)

Correspondence Address: Richard Brewster Main, Esq., Patents Pending, 9832 Lois Stiltner Court, Elk Grove, CA, 95624, US

(21) Appl. No.: 12/537,253

(22) Filed: Aug. 7, 2009

(51) Int. Cl. F02F 1/40; F01M 1/02; F01L 7/00; F02B 33/04

(52) U.S. Cl. 123/41.82 R; 123/196 R; 123/190.8; 123/73 R

(57) ABSTRACT

A two-cycle dry-sump fuel-injected engine includes a cylinder block with piston bores that step up substantially in diameter between the top of each cylinder and the bottom. A matching piston similarly steps in its outside diameter with a larger diameter lower skirt having an oil seal ring. A narrower diameter of the piston involves the top better part of its length. A jacket chamber all around the piston changes in volume as the piston travels. A combustion chamber has an exhaust valve and a fuel injector. The jacket chamber provides a pump for an oil mist and air lubrication system. Fresh air is drawn into the crankcase. When the piston moves all the way down, the fresh air is compressed by the larger displacement volume of the larger diameter piston skirt and transferred through to a smaller displacement volume of the upper piston to completely scavenge the exhaust.

### BACKGROUND OF THE INVENTION

1. Field of the Invention

The present invention relates to internal combustion engines, and more particularly to two-cycle engines with fuel injection and dry sumps.

2. Description of Related Art

Internal combustion engines are universally available in two stroke and four stroke varieties, sometimes called two-cycle and four-cycle. The four cycle types include diesel engines that inject fuel directly into the combustion chamber where very high compression pressures are used ignite the fuel. Other four cycle types, especially those used in cars, use lower compression ratios and a spark to ignite the air-fuel mixture.

A two-cycle engine completes each power cycle in two strokes of the piston, down and then up. The down stroke of the piston near bottom dead center (BDC) reveals both the exhaust and intake ports in the sides of the cylinder, and so the exhaust gases are expelled at the same time a fresh fuel-air mixture is being inducted. On the up stroke of the piston, the exhaust and intake transfer ports are closed and the inducted fuel-air is compressed. Near top dead center (TDC) of the piston travel, a spark plug in the combustion chamber ignites the compressed fuel-air mixture, and the explosive pressures drive the piston down.

The disadvantages of the two-cycle engine include the inefficiencies and pollution caused by the mixing of the exhaust gases with the fresh fuel-air intake. Oil must also be mixed in with the fuel to lubricate the internal working parts, and some of this oil makes its way to the combustion chamber. So producing a clean burning two-cycle engine good enough for use in vehicles and modern Environmental Protection Agency (EPA) Standards has been difficult to impossible.

Four cycle engines separate the power cycle into four strokes of the piston timed with intake and exhaust valves in the combustion chamber. A first stroke, down on the piston draws in a fuel-air mixture through an open intake valve. The intake and exhaust valves are closed and the following up stroke of the piston compresses the fuel-air mixture. Near TDC, a spark plug fires, and the explosive pressures drive the piston down hard in the third, power stroke. On the fourth stroke, the piston moves up from BDC and the exhaust valve opens, causing the exhaust gases to be expelled. The four strokes are therefore, intake, compression, power, and exhaust.

A principal disadvantage of the four-cycle engine is that only one power stroke occurs every two revolutions of the crankshaft. In a two-cycle engine, there is a power stroke every revolution.

### SUMMARY OF THE INVENTION

Briefly, a two-cycle fuel-injected engine embodiment of the present invention comprises a cylinder block with piston bores that step up substantially in diameter between the top of each cylinder and the bottom. A matching piston similarly steps in its outside diameter with a larger diameter lower skirt having an oil seal ring. Two-compression rings are disposed in the top, narrower diameter of the piston that involves the top 80% of its length. This creates a jacket chamber all around the piston that changes in volume as the piston travels up and down. A combustion chamber is disposed above the piston, and it has an exhaust valve similar in workings to a four-cycle engine. A fuel injector is connected to the combustion chamber like that of a diesel engine. The jacket chamber provides a pump for an oil mist and air lubrication system. Fresh air with no oil or fuel is drawn into the crankcase by the vacuum caused there when the piston travels up. When the piston moves all the way down, the fresh air is compressed by the larger displacement volume of the larger diameter piston skirt. A port in the side of the cylinder bore opens up and the compressed fresh air is forced into the smaller displacement volume of the upper piston.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1A is a cross sectional view diagram of a two-cycle fuel-injected engine embodiment of the present invention with the piston shown at its bottom dead center position;

FIG. 1B is a cross sectional view diagram of the two-cycle fuel-injected engine of FIG. 1A with the piston shown at its top dead center position;

FIG. 2 is a perspective view diagram of the two-cycle fuel-injected engine of FIGS. 1A-1B showing the cylinder block and head removed to reveal the stepped piston configuration;

FIG. 3 is a perspective view diagram of the backing plate and timing chain assembly for the two-cycle fuel-injected engine of FIGS. 1A-1B and 2; and

FIG. 4 is a perspective view diagram of the top end and exhaust valve assembly for the two-cycle fuel-injected engine of FIGS. 1A-1B, 2, and 3.

### DETAILED DESCRIPTION OF THE INVENTION

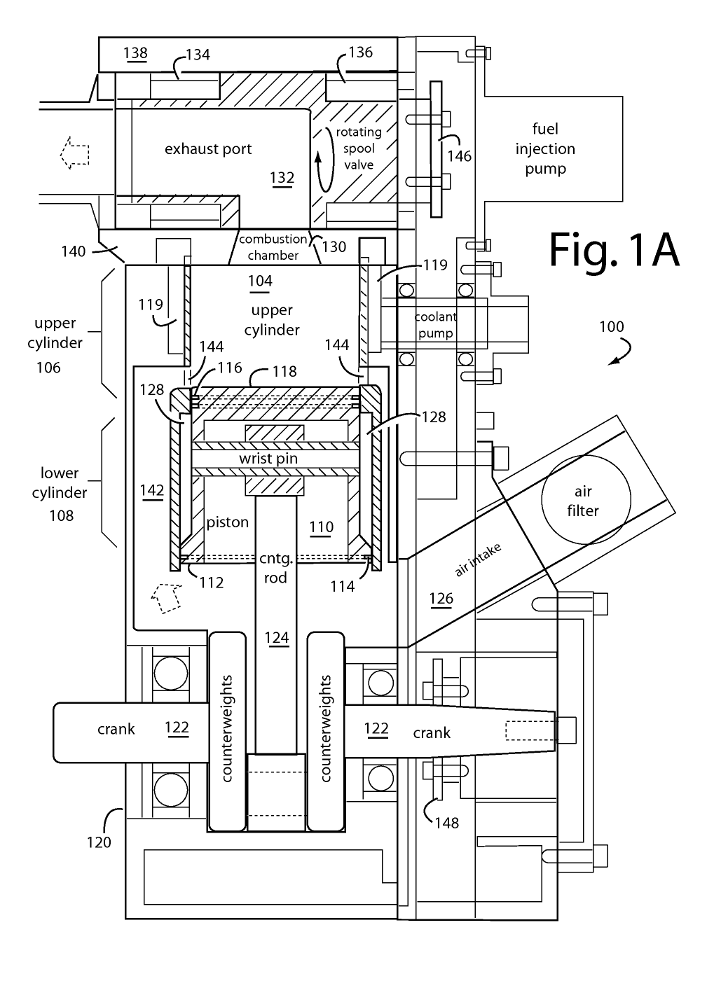

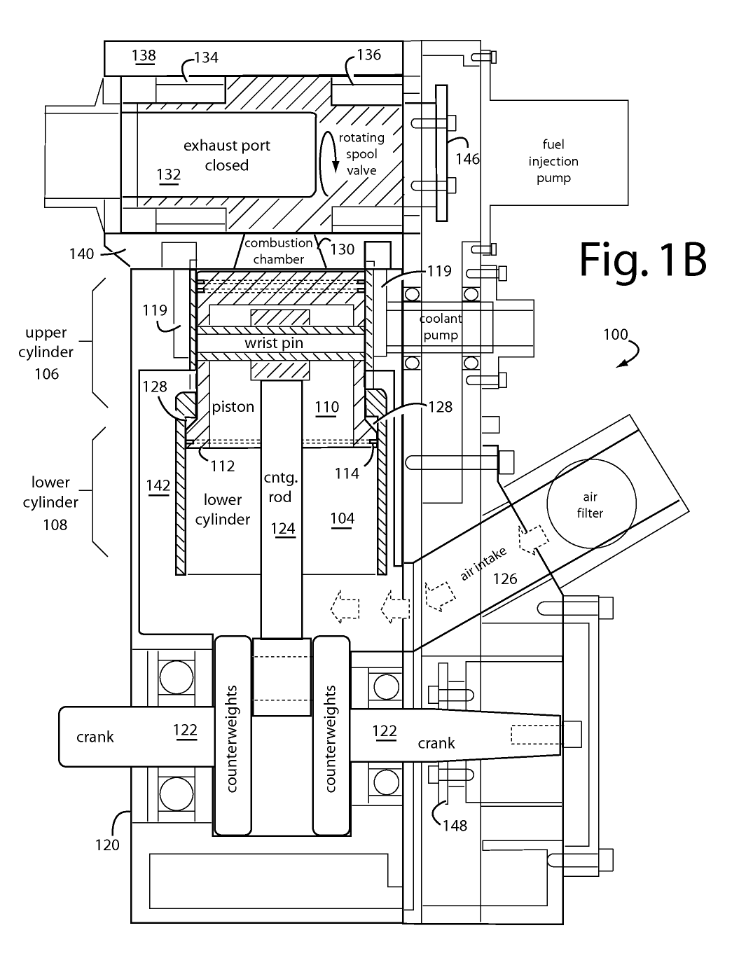

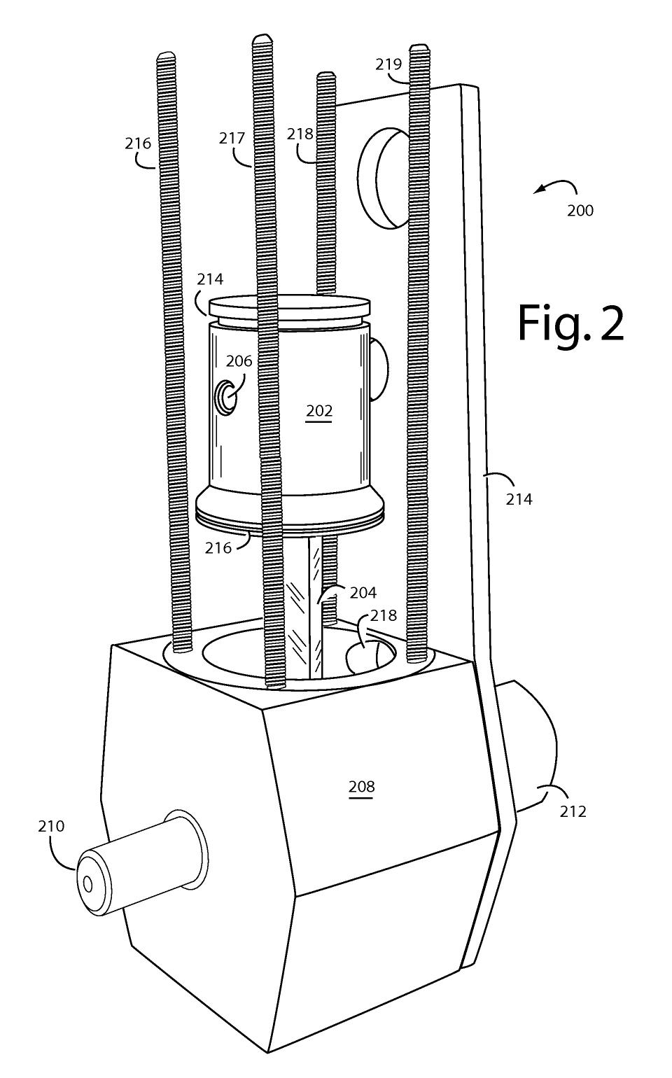

FIG. 1 illustrates an internal combustion engine embodiment of the present invention, and is referred to by the general reference numeral 100. Engine 100 comprises a cylinder block 102 with a piston or cylinder bore that steps up substantially in diameter between a top portion 106 of each cylinder and a corresponding bottom portion 108. A piston 110 has steps in its diameter matching the cylinder bores. Its outside diameter has a larger diameter lower half with a piston skirt 112 and a seal ring 114, and an upper half with at least one compression ring 116 is disposed near a top 118. FIG. 2 shows the piston design intended more clearly. Liquid cooling is provided around upper cylinder 106 by a coolant jacket 119.

A crankcase 120 encloses a crankshaft 122 with a connecting rod 124 attached to piston 110. Crankcase 120 includes a port 126 to intake fresh air for combustion. A jacket chamber 128 surrounds the piston 110, and changes in volume as the piston 110 travels up and down as a consequence of there being matching stepped diameters on the piston and corresponding cylinder bore. A combustion chamber 130 is disposed above the piston 110. A fuel injector (not visible in FIGS. 1A and 1B) is connected to one side of combustion chamber 130 and provides for the injection of fuel at particular times to create an air-fuel mixture.

A spark plug (also not visible in FIGS. 1A and 1B) is similarly disposed in the combustion chamber 130 on the opposite side of the fuel injector, and provides for the igniting of the air-fuel mixture at particular times.

A rotary spooling exhaust valve 132 vents out exhaust gases from the combustion chamber 130 at particular times. It rotates between lubricated bushings 134 and 136. These are housed inside a top cover 138 that fits on top of a cylinder head 140.

Above piston top 118, a set of grooves (not shown) are cut into head 140 around combustion chamber 130 to induce a turbulent air flow entering the combustion chamber as the piston rises up to top dead center. The swirl makes for more effective fuel injection atomization.

An air transfer port 142 connects the internal volume of crankcase 120 to intake ports 144 disposed in a lower side of each said top portion 106 of cylinder 104. Such provides for a charge of fresh air into the combustion chamber 130 that was first drawn into the crankcase by an upstroke of said lower half 112 of piston 110.

A two-cycle operation is thus supported. From BDC to TDC, the exhaust is vented out the top and fresh air is ported in. The upstroke compresses the air coming in from the crankcase, and fuel is injected into the combustion chamber with a spark. From TDC to BDC, the explosive pressures power the piston down, to repeat the cycle.

A pair of sprockets 146 and 148 and a timing chain (not shown in FIGS. 1A and 1B) connecting them are respectively mounted on rotary spooling exhaust valve 132 and crankshaft 122. The timing chain and sprocket arrangement provides for coordinated times of operation amongst the fuel injector, spark plug, and exhaust valve, relative to rotation of the crankshaft and the travel position of the piston.

Although engine 100 operates with a dry sump, a contained oil mist and air lubrication system is included that employs jacket chamber 128 as a pump to distribute oil droplets to the internal moving parts including the piston, crankshaft, and exhaust valve through oil galleys. FIG. 1A and 1B don't offer the right views to see how the parts interrelate and function. Essentially, an air intake receives an oil mist as it is drawn each cycle into jacket chamber 128. That helps lubricate piston 110 inside cylinder 104 and can reach a piston wrist pin 150 and the top end of connecting rod 124. One branch of a passageway (not shown) leads up to bushings 134 and 136 to lubricate them and rotating spooling exhaust valve 132. Another branch pressurizes an oil flow through galleys in crankcase 120 and crankshaft 122.

Engine 100 has a dry sump, no oil or oil mist is carried around by the intake air for the purposes of lubrication.

The top 118 of piston 110 and the interior of exhaust valve port 132 are ceramic coated to reduce heat absorption. The air/oil pump jacket 128 around stepped piston 110 contributes to cooling of the hottest engine components, especially the piston itself.

There is a dual functionality to stepped piston 110. The stepping in diameter on the sides is used to pump oil, and it contributes to improved cylinder exhaust scavenging because the lower cylinder 108 pushes a greater volume of air than exists in the upper cylinder 106.

The disparity in cylinder volume provides for a complete purging of the exhaust gases that is only possible because the fuel is direct injected and not carried in with the intake needed to scavenge out the exhaust.

The fuel injection and spark timing are synchronized to control the combustion. Fuel is injected at very high pressure an instant prior to ignition spark, so much higher compression ratios and greater spark advance are possible because pre-ignition and detonation are eliminated.

Engine 100 can be made with a wet liner cylinder sleeve, so the cylinder will project into the head and eliminate the need for a head gasket.

FIG. 2 shows part of an internal combustion engine embodiment of the present invention, and is referred to by the general reference numeral 200. Engine 200 is missing its cylinder sleeve, cylinder head, exhaust valve and other top end parts. This allows a stepped piston 202 on a connecting rod 204 with a wrist pin 206 to be clearly shown. A crankcase 208 houses a crankshaft 210 with an exposed main bearing 212. A backing plate 214 supports various timing components like the timing sprockets and chain that connect the crankshaft 210 to the exhaust valve. Four long head bolts 216-219 are used to secure a cylinder block and head.

Ring grooves 214 and 216 at the top and bottom, respectively, of piston 202 are shown without the compression and oil control rings themselves. There may also be provided two grooves at the top for two compression rings. A combustion air intake 218 brings fresh air from outside into the crankcase 208.

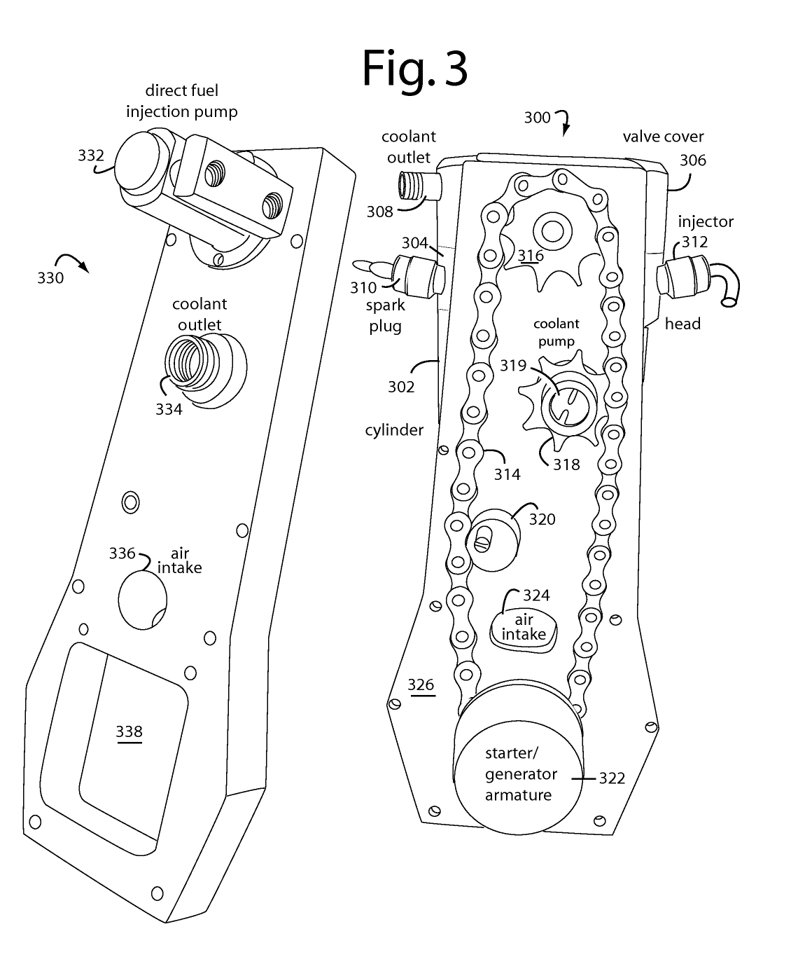

FIG. 3 represents the back side of an internal combustion engine embodiment of the present invention, and is referred to by the general reference numeral 300. Engine 300 has a cylinder block 302 on top of which are mounted a cylinder head 304 and an exhaust valve cover 306 fitted with an coolant inlet 308. A spark plug 310 and a fuel injector 312 are positioned on opposite sides of cylinder head 304. A timing chain 314 wraps around an exhaust valve timing sprocket 316, a sprocket 318 on an axial flow coolant pump 319, a eccentric timing chain adjuster 320, and a crankshaft sprocket (not visible behind a starter/generator armature 322).

The starter/generator armature 322 is matched with a stator winding and rectifier in a cover plate (not shown), and the one unit serves to both start the engine and generate electrical power when the engine is running.

A combustion air intake 324 with one-way valves ports fresh air from the outside into the crankcase. There is no air throttle, the engine speed is controlled by the fuel injection and ignition timing.

A backing plate 326 supports the timing assembly to the engine 300. The moving parts on the near side of the backing plate 326 are all enclosed by a timing chain cover 330.

A direct fuel injection pump 332 is driven by exhaust valve timing sprocket 316 so that the timing of the fuel injection will be correct. Alternatively, electronic fuel injectors can be used and may have some advantages with pollution controls. And coolant outlet 334 communicates with coolant 319. An air intake 336 passages combustion air on through combustion air intake 324 into the crankcase. A clearance hole 338 allows main crank bearing 322 to pass through into a removable bearing cap (not shown).

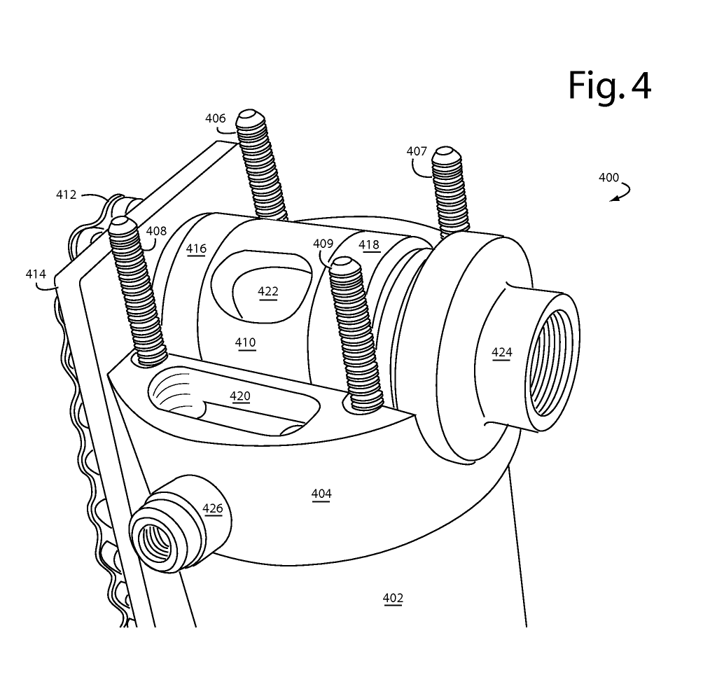

FIG. 4 represents the top end of an internal combustion engine embodiment of the present invention, and is referred to by the general reference numeral 400. Engine 400 has a cylinder block 402 on top of which are mounted a cylinder head 404 and an exhaust valve assembly. A cover to the exhaust valve assembly has been removed for purposes of this illustration. It, and the cylinder block 402 and cylinder head 404 are bolted down with four head bolts 406-409.

The exhaust valve assembly comprises a rotating spool valve 410 that is driven by a timing chain 412 connected to the crankshaft. A shaft connecting the rotating spool valve 410 passes through a backing plate 414. A pair of bushing rings 416 and 418 include exhaust gas seals and are lubricated by oil mist. A coolant port 420 communicates coolant through to coolant outlet 308 (FIG. 3). An exhaust port 422 vents a combustion chamber inside cylinder head 404 once every rotation of the crankshaft. The exhaust gases pass out through an exhaust outlet 424. A fuel injector 426 provides for direct injection (DI) into combustion chamber inside cylinder head 404, and a spark plug (not visible in FIG. 4) is positioned on the opposite side.

An alternative air intake system that may be easier to manufacture includes a rotary spool valve similar to the rotary spool exhaust valve in FIG. 4, but located in the crankcase. Such rotary spool intake valve can be driven by timing chain 412.

Oil flow through crankshaft 122 (FIG. 1) allows for a dry sump, and is novel in two-stroke engines. Oil is not injected nor mixed into the fuel, allowing the crankcase sump to remain dry. Smoke and pollutants can be eliminated to levels common to four stroke engine. The complete separation of the fuel intake and exhaust strokes greatly reduces unburned hydrocarbons, thereby making it possible for engine 100 to comply with stringent modern EPA standards.

In general, rotary spool valves are preferred for the exhaust and intake because they eliminate reciprocating parts in the valve train, a primary limitation in engine speed in all conventional engines. Higher revving engines are made possible in smaller packages, and with increased reliability.

A method for complete scavenging of exhaust gases in a two-cycle internal combustion engine comprises configuring a piston and a cylinder in which the piston is disposed to have an upper section diameter that is smaller than a remaining lower section diameter. Then, transferring air without fuel or oil from a crankcase larger volume beneath the lower section diameter of the piston and cylinder to a smaller volume above the upper section diameter of the piston and cylinder while an exhaust valve is open. Thus an excess volume of air from said crankcase passes through a combustion chamber and said exhaust valve without first being used in combustion. Only then fuel is injected and a spark is used to ignite a compressed fuel-air mixture about the time the piston reaches the top of its travel inside the cylinder and well after the exhaust valve has closed. This provides a more efficient use of the fuel, and results in reduced emissions and pollution.

Although particular embodiments of the present invention have been described and illustrated, such is not intended to limit the invention. Modifications and changes will no doubt become apparent to those skilled in the art, and it is intended that the invention only be limited by the scope of the appended claims.

1. An internal combustion engine, comprising:
a cylinder block with piston bores that step up substantially in diameter between a top portion of each cylinder and a corresponding bottom portion;
a piston with steps matching said piston bores and its outside diameter having a larger diameter lower half with a piston skirt and a seal ring, and an upper half with at least one compression ring disposed near the top;
a crankcase and a crankshaft with a connecting rod attached to the piston, and including a port to intake fresh air for combustion;
a jacket chamber surrounding the piston that changes in volume as the piston travels up and down as a consequence of there being matching stepped diameters on the piston and corresponding cylinder bore;
a combustion chamber disposed above the piston;
a fuel injector connected to the combustion chamber and providing for the injection of fuel at particular times to create an air-fuel mixture;
a spark plug disposed in the combustion chamber and providing for the igniting of said air-fuel mixture at particular times;
an exhaust valve for venting out exhaust gases from the combustion chamber at particular times; and
an air passageway connecting from the crankcase to a port disposed in a lower side of each said top portion of each cylinder, and that provides for a charge of fresh air into the combustion chamber that was first drawn into the crankcase by an upstroke of said lower half of the piston;
wherein, a two-cycle operation is supported.

2. The internal combustion engine of claim 1, further comprising:
a sprocket and timing chain attached between each of the crankshaft and exhaust valve, and providing for coordinated times of operation of the fuel injector, spark plug, and exhaust valve relative to rotation of the crankshaft and the travel position of the piston.

3. The internal combustion engine of claim 1, further comprising:
an oil mist and air lubrication system that employs the jacket chamber as a pump to distribute oil droplets to any internal moving parts including the piston, crankshaft, and exhaust valve.

4. The internal combustion engine of claim 1, further comprising:
a rotary spool valve fitted at each end with bushings and mounted adjacent to the combustion chamber for sealing it shut, and further for implementing the exhaust valve that vents out exhaust gases from the combustion chamber at said particular times.

5. The internal combustion engine of claim 1, further comprising:
a liquid coolant jacket surrounding said a top portion of each cylinder and providing for the circulation of a coolant.

6. The internal combustion engine of claim 1, further comprising:
an oiling system included in the crankcase and crankshaft that enable dry sump operation.

7. A method for complete scavenging of exhaust gases in a two-cycle internal combustion engine, comprising:
configuring a piston and a cylinder in which the piston is disposed to have an upper section diameter that is smaller than a remaining lower section diameter;
transferring air without fuel or oil from a crankcase larger volume beneath said lower section diameter of the piston and cylinder to a smaller volume above said upper section diameter of the piston and cylinder while an exhaust valve is open, wherein an excess volume of air from said crankcase passes through a combustion chamber and said exhaust valve without first being used in combustion; and
injecting fuel and igniting a compressed fuel-air mixture about the time the piston reaches the top of its travel inside the cylinder and after said exhaust valve is closed;
wherein, a more efficient use of said fuel results and with reduced emissions of pollutants.

8. The method of claim 7, further comprising:
circulating lubricating oil in a dry sump system such that air transferred to said combustion chamber will be substantial free of oil.

9. The method of claim 7, further comprising:
employing a changing volume of a jacket surrounding the piston and inside the cylinder to pump lubricating oil throughout the engine.

10. The method of claim 7, further comprising:
disposing a liquid coolant jacket around said upper section of the cylinder and combustion chamber and circulating coolant through it and around said exhaust valve.

11. The method of claim 7, further comprising:
using a rotary spooling valve to implement at least one of the exhaust valve and an intake valve.
